(19) United States
(12) Patent Application Publication
(10) Pub. No.: US 2004/0233586 A1
(43) Pub. Date: Nov. 25, 2004

(54) Magnetic head

(75) Inventor: Takashi Suda, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/791,538

(22) Filed: Mar. 3, 2004

(30) Foreign Application Priority Data
Mar. 4, 2003 (JP) 2003-056646

(51) Int. Cl. G11B 5/127

(52) U.S. Cl. 360/313; 360/122

(57) ABSTRACT

Provide is a magnetic head which, even when pressure is applied to the sliding surface of the substrate of the magnetic head during the reproduction of signals on a magnetic tape, particles of material constituting the substrate do not separate from the surface of the substrate and the edge portion of the substrate is not ground. The magnetic head comprises a film comprised of diamond-like carbon between a substrate and an insulating layer.

### FIELD OF THE INVENTION

The present invention relates to a magnetic head, in particular, to a magnetoresistive magnetic head, having improved electromagnetic characteristics during reproduction.

### BACKGROUND OF THE INVENTION

Magnetic tapes, a form of magnetic recording media, have been widely employed as signal recording tapes for recording and/or reproducing signals such as data. In recent years, to increase the recording density per unit area, attempts have been made to narrow the track width of magnetic tapes. In response to the narrowing of the track width of magnetic tapes, attempts have been made to narrow the magnetic gap width (gap narrowing) of the magnetic heads employed in magnetic recording and reproducing devices. In order to achieve the gap narrowing by thin-film forming techniques, magnetoresistive heads have been widely employed (see Japanese Unexamined Patent Publication (KOKAI) Heisei No. 8-273126).

FIG. 5 is a sectional view showing the principal components of a conventional magnetoresistive head. As shown in FIG. 5, the conventional magnetoresistive head 30 is formed using a thin-film forming technique by sequentially stacking on a substrate 31 comprised of a nonmagnetic material an insulating layer 32 comprised of an insulating material, a lower shield layer 33 comprised of a magnetic material, a lower gap layer 34 comprised of a nonmagnetic material, a magnetoresistive element 35, an upper gap layer 36 comprised of a nonmagnetic material, an upper shield layer 37 comprised of a magnetic material, and a protective layer 38 comprised of an insulating material. Here, the portion sandwiched between lower shield layer 33 and upper shield layer 37 serves as the magnetic gap G for reading in magnetoresistive head 30. Alumina titanium carbide (AlTiC: Al₂O₃·TiC), a nonmagnetic material, is often employed for substrate 31. Alumina (Al₂O₃) or silica (SiO₂), both of which are insulating materials, are often employed for insulating layer 32.

However, in a conventional magnetoresistive head 30 such as is shown in FIG. 5, particularly when a polycrystalline substance such as AlTiC is employed for substrate 31, there is a problem in that when the magnetic tape slides on magnetoresistive head 30 during reproduction of signals on a magnetic tape, and pressure is applied on the surface of substrate 31 sliding against the magnetic tape (the sliding surface), the pressure causes the particles of AlTiC constituting substrate 31 to separate from the surface of substrate 31.

One of the reasons the pressure acting on the sliding surface of substrate 31 causes the particles of AlTiC constituting substrate 31 to separate from the surface of substrate 31 is thought to be that when forming insulating layer 32 as an underlayer on substrate 31 during the process of manufacturing magnetoresistive head 30, the shock during film formation causes the oxygen atoms (O) contained in insulating layer 32 to penetrate into substrate 31, bonding with the aluminum (Al) and titanium (Ti) contained in substrate 31 and forming oxides, thereby impeding bonding between the aluminum, titanium, and carbon constituting substrate 31.

When the particles of AlTiC are separated from the surface of substrate 31, the surface of substrate 31 becomes rough and smoothness is deteriorated. Thus, during reproduction of signals on the magnetic tape, the frictional force between magnetoresistive head 30 and the magnetic tape increases, resulting in the deterioration of the sliding characteristics of the magnetic tape, thereby preventing magnetoresistive head 30 from correctly reading the signal from the magnetic tape.

Since the alumina and silica constituting insulating layer 32 are softer than the AlTiC constituting substrate 31, when AlTiC particles are separated from the surface of substrate 31, they rub against the surface (sliding surface) of the individual layers that are from insulating layer 32 to protective layer 38 and slide against the magnetic tape. Thus, during reproduction of signals on the magnetic tape, a space ends up forming between the magnetic tape and magnetoresistive head 30, making it impossible for magnetoresistive head 30 to correctly read the signal from the magnetic tape.

Further, due to a difference in hardness between the substrate materials and the insulating layer materials, extended sliding against the tape produces uneven abrasion. As this uneven abrasion becomes more pronounced, the force applied to the edge of the substrate between the substrate and the insulating layer increases. As a result, there is a problem in that as the uneven abrasion progresses still further, a groove is made by grinding the edge portion of the substrate between the substrate and the insulating layer, producing a spacing loss between the magnetic tape and the magnetoresistive head; head contact decreases; and electromagnetic characteristics deteriorate.

Accordingly, it is an object of the present invention to provide a magnetic head which, even when pressure is applied to the sliding surface of the substrate of the magnetic head during the reproduction of signals on a magnetic tape, particles of material constituting the substrate do not separate from the surface of the substrate and the edge portion of the substrate is not ground.

### SUMMARY OF THE INVENTION

The present inventors conducted extensive research into the above-stated problem, resulting in the discovery that by providing a high-strength film comprised of diamond-like carbon between the substrate and the insulating layer, it was possible to prevent the separation of substrate material particles and improve electromagnetic characteristics during signal reproduction; the present invention was devised on that basis.

That is, the present invention relates to a magnetic head comprising a film comprised of diamond-like carbon (hereinafter, referred to as “diamond-like carbon film”) between a substrate and an insulating layer.

In the present invention, it is preferred that the film has a Vickers hardness equal to or greater than 2000 kg/mm²;

the film has a thickness equal to or greater than 100 nm; and

the magnetic head is a magnetoresistive head.

The magnetic head according to the present invention may comprises the diamond-like carbon film, the insulating layer, a lower shield layer, a lower gap layer, a magnetoresistive element, an upper gap layer, an upper shield layer, and a protective layer in this order on one side surface of the substrate.

In the magnetic head according to the present invention,

the substrate may be comprised of a nonmagnetic material, and

the diamond-like carbon film, the insulating layer comprised of an insulating material, a lower shield layer comprised of a magnetic material, a lower gap layer comprised of a nonmagnetic material, a magnetoresistive element, an upper gap layer comprised of a nonmagnetic material, an upper shield layer comprised of a magnetic material, and a protective layer comprised of an insulating material may be provided in this order on one side surface of the substrate.

### BRIEF DESCRIPTION OF DRAWINGS

FIG. 1 shows a sectional view of the main part of a magnetoresistive head of the present invention.

FIG. 2 shows a perspective view of the magnetoresistive head shown in FIG. 1.

FIG. 3 shows sectional views descriptive of the method of manufacturing the magnetoresistive head shown in FIG. 1: (a) shows the state following formation of a diamond-like carbon film, (b) shows the state following formation of an insulating layer, and (c) shows the state following formation of a lower shield layer and a lower gap layer.

FIG. 4 shows sectional views descriptive of the method of manufacturing the magnetoresistive head shown in FIG. 1: (a) shows the state following formation of a magnetoresistive layer and an upper gap layer, (b) shows the state following formation of an upper shield layer, and (c) shows the state following formation of a protective layer.

FIG. 5 shows a section view of the main part of a conventional magnetoresistive head.

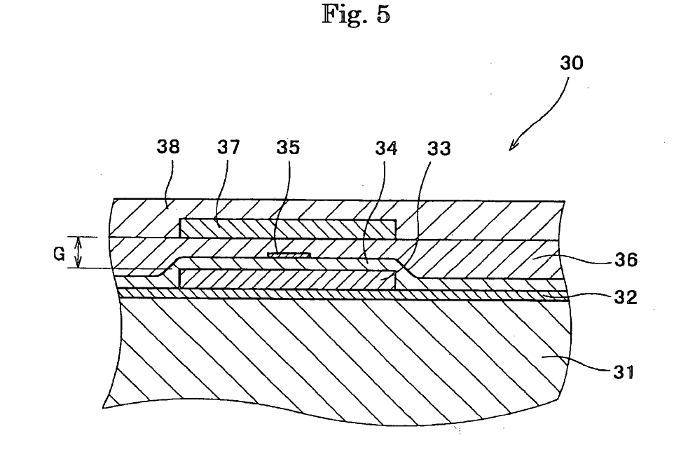

The present invention will be described in greater detail below.

The magnetic head of the present invention comprises a diamond-like carbon (also referred to as “DLC”, hereinafter) film between an insulating layer and a substrate.

DLC refers to a thin carbon film of high hardness that is similar to diamond and is synthesized by a vapor phase synthesis method employing ions. It is considered that the structure of a DLC film is normally amorphous, comprises some hydrogen, and contains some diamond bonds and some graphite bonds. A DLC film, due to its amorphous structure, does not have crystal grain boundaries, but has a surface that is extremely flat compared to the surfaces of hard thin films of polycrystalline structure, such as titanium nitride. Such smooth surface and physical properties of a carbon material are thought to impart good friction and abrasion characteristics to DLC films.

The effects achieved by providing a hard DLC film having good frictional and abrasive characteristics between a nonmagnetic substrate and an insulating layer in the present invention will be described below.

In the present invention, during the formation of the insulating layer as an underlayer on the substrate in the course of manufacturing the magnetic head, the penetration of oxygen atoms (O) contained in the insulating layer into the substrate can be prevented by providing a DLC film between the insulating layer and the substrate. Accordingly, since the bonds between the various atoms in the material constituting the substrate are preserved, particles of material constituting the substrate are prevented from separating from the surface of the substrate even when pressure is applied to the sliding surface of the substrate during the reproduction of signals on a magnetic tape.

Further, in the present invention, since a DLC film is provided on the substrate, an edge portion of the substrate—the portion that is ground the most markedly by sliding against the magnetic tape—is covered with hard DLC. Therefore, the edge portion of the substrate is hardly ground by sliding against the magnetic tape and a magnetic head with good electromagnetic characteristics is obtained.

The DLC film preferably has a Vickers hardness equal to or greater than 2,000 kg/mm², more preferably has a Vickers hardness of 3,000 to 4,000 kg/mm². When the Vickers hardness of the DLC film is equal to or greater than 2,000 kg/mm², the edge portion of the substrate is effectively prevented from grinding due to sliding against the tape.

As set forth above, a DLC film is provided between a substrate and an insulating layer in the present invention as a measure to counter uneven abrasion due to sliding against the magnetic medium of an insulating layer of Al₂O₃ or the like, and prevent grinding of the edge portion of the substrate. Since a DLC film becomes weak when thin, to achieve this effect, the thickness of the DLC film is preferably equal to or greater than 100 nm, more preferably from 200 to 1,000 nm.

The magnetic head of the present invention may be, for example, a magnetoresistive magnetic head (also referred to as “MR head”, hereinafter). The structure of an MR head will be described below with reference to suitable figures. However, the present invention is not limited to this embodiment.

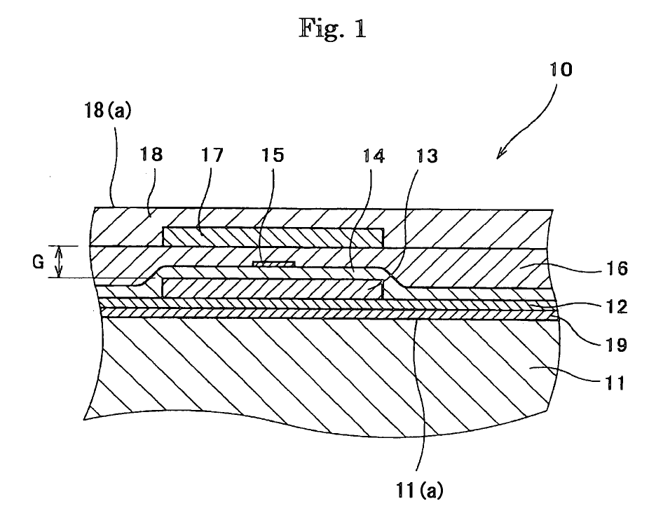

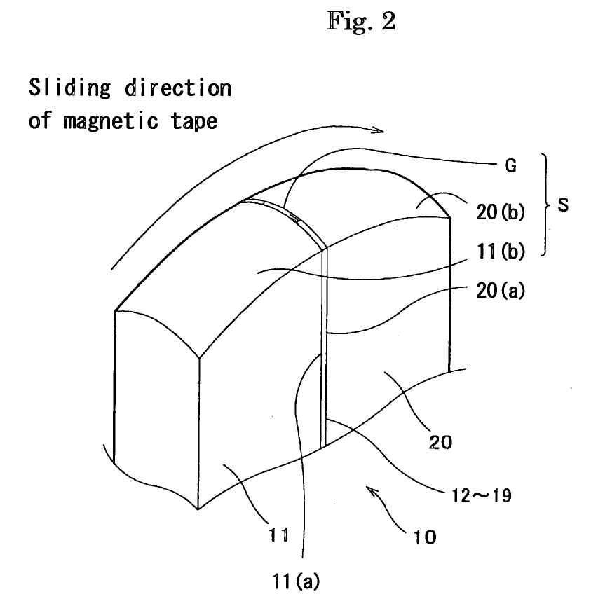

FIG. 1 is a sectional view of the main part of a magnetoresistive head of the present invention. FIG. 2 is a perspective view of the magnetoresistive head shown in FIG. 1. In FIG. 1, to facilitate comprehension, the thickness of each layer has been depicted in an exaggerated fashion.

As shown in FIG. 1, MR head 10 comprises DLC film 19 on one side surface 11(a) of substrate 11 and insulating layer 12 thereon. On insulating layer 12, lower shield layer 13, lower gap layer 14, magnetoresistive element (also referred to hereinafter as an “MR element”) 15, upper gap layer 16, upper shield layer 17, and protective layer 18 are formed in this order. Here, the portion sandwiched between lower shield layer 13 and upper shield layer 17 serves as a magnetic gap G for reading in MR head 10.

Further, protective plate 20 (see FIG. 2) is bonded to one side surface 18 (a) (see FIG. 1) of protective layer 18. One side surface 20(a) of protective plate 20 together with one side surface 11(a) of substrate 11 sandwich DLC film 19, insulating layer 12, lower shield layer 13, lower gap layer 14, MR element 15, upper gap layer 16, upper shield layer 17, and protective layer 18 (see FIG. 2).

Further, as shown in FIG. 2, one end surface 11(b) of substrate 11 and one end surface 20(b) of protective layer 20 are formed in a curved manner, so that end surface 11(b) and end surface 20(b) function as a sliding surface S of the magnetic tape that is the surface of MR head 10 against which slides the magnetic tape during reproduction of signals on the magnetic tape. The sliding surface S of the magnetic tape is formed with a curved surface gently bowing outward in the running direction of the magnetic tape.

The aforementioned magnetic gap G for reading is exposed on the sliding surface S of the magnetic tape. When the magnetic tape passes over the magnetic gap G, signals that are recorded as magnetic fields on the magnetic tape can be read through the magnetic gap G by MR element 15. Specifically, during reproduction of signals on the magnetic tape, a sensing current, that is a constant current, is passed through MR element 15 to detect changes of electric resistance as changes in voltage, thereby permitting reading of signals recorded on the magnetic tape.

In the present invention, substrate 11 can be comprised of AlTiC (Al₂O₃·TiC), which is a nonmagnetic material. Further, substrate 11 can be comprised of a nonmagnetic material such as a —Fe₂O₃ (α-hematite), NiO—TiO₂—MgO, TiO₂—CaO, and NiO—MnO, or a magnetic material such as Ni—Zn ferrite and Mn—Zn ferrite.

One side surface 11(a) of substrate 11 is formed to be approximately rectangular in shape. On one side surface 11(a), DLC film 19, insulating layer 12, lower shield layer 13, lower gap layer 14, MR element 15, upper gap layer 16, upper shield layer 17, and protective layer 18 are sequentially formed. One end layer 11(b) of substrate 11, in combination with one end layer 20(b) of protective plate 20, constitutes the sliding surface S of the magnetic tape (see FIG. 2). For example, the thickness of the substrate may range from 60 to 100 μm.

Insulating layer 12, for example, may be comprised of alumina (Al₂O₃) or silica (SiO₂), both of which are insulating materials. Further, insulating layer 12 may be comprised of AlN, Al—N—X (where X denotes one or more of Si, B, Cr, Ti, Ta and Nb), SiN, SiC, DLC, BN, MgO, SiAlON, AlON, Si₃Na, SiCO, SiON, SiCON, or the like. For example, the thickness of insulating layer 12 may range from 15 to 30 μm.

Lower shield layer 13 and upper shield layer 17 may be comprised of, for example, a magnetic material such as Fe—Si—Al alloy (Sendust), Ni—Fe alloy (Permalloy), Ni—Zn alloy (hematite), or some other polycrystalline ferrite. However, the material constituting the shield layer is not specifically limited but is selected from materials affording good soft magnetism and performing well with respect to abrasion and corrosion. The shield layer mentioned above must be able to correspond to all wavelengths employed in the system in order to function as the magnetic shield of an MR head, and normally has a film thickness of two or more times the length of the maximum wavelength. The thickness of lower shield layer 13 may range, for example, from 2 to 4 μm. The thickness of upper shield layer 17 may range, for example, from 2 to 4 μm. The lower shield layer and the upper shield layer may be comprised of the same material or of different materials.

Lower gap layer 14 and upper gap layer 16 may be, for example, comprised of a nonmagnetic material such as alumina (Al₂O₃) or silica (SiO₂).

The MR element can be accurately arranged at a center position between the pair of magnetic shields by determining the thickness td of the lower gap layer by the following expression: t_{d}=G/2−(thickness of the magnetoresistive layer (for example, an NiFe layer)/2+thickness of the nonmagnetic layer (for example, a Ta layer)), wherein the distance between the shields finally required by the system is denoted as G. Further, the MR element can be accurately positioned at a center position between the pair of magnetic shields by determining the thickness tᵤ of the upper gap layer by the following expression: tᵤ=(thickness of a nonmagnetic layer (for example, a Ta layer)+thickness of a soft magnetic layer (for example, a NiFeNb layer)+thickness of a nonmagnetic layer (for example, a Ta layer)+thickness of a magnetoresistive layer (for example NiFe layer)/2). The thickness of lower gap layer 14 can range, for example, from 60 to 140 nm. The thickness of upper gap layer 16 can range, for example, from 80 to 160 nm. However, the thickness and material employed in the gap layers are not specifically limited; it suffices to select a suitable material based on the use objective of the MR head and suitably set the thickness. The upper gap and lower gap layers may be comprised of the same material or different materials.

One example of MR element 15 is an MR element in which a lower layer in the form of a tantalum layer about 5 nm in thickness, a SAL bias layer in the form of a NiFeNb layer about 32 nm in thickness, an intermediate insulating layer in the form of a tantalum layer about 5 nm in thickness, a magnetoresistive layer in the form of a NiFe layer about 30 nm in thickness, and an upper layer in the form of a tantalum layer about 1 nm in thickness are sequentially formed in this order by sputtering or the like. In this MR element, the NiFe layer is a soft magnetic layer having a magnetoresistive effect, serving as the magnetically sensitive element of the MR element. In this MR element, the NiFeNb layer serves as a SAL layer applying a bias magnetic field to the NiFe layer. However, the thickness and material of the MR element are not specifically limited; it suffices to select a suitable material based on the use objective of the MR head and suitably set the thickness.

Protective layer 18, in the same manner as insulating layer 12 mentioned above, may be comprised of an insulating material such as alumina (Al₂O₃) or silica (SiO₂). So long as the material of protective layer 18 is a nonmagnetic, electrically conductive material, other materials may also be employed. However, when resistance to the environment and resistance to abrasion are taken into account, alumina (Al₂O₃) and silica (SiO₂) are suitably employed. The thickness of protective layer 18 may range, for example, from 2 to 6 μm.

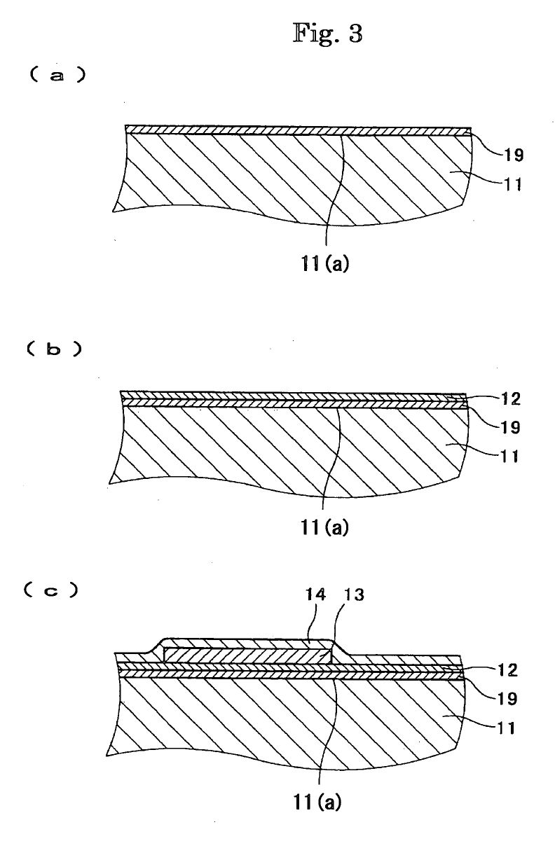

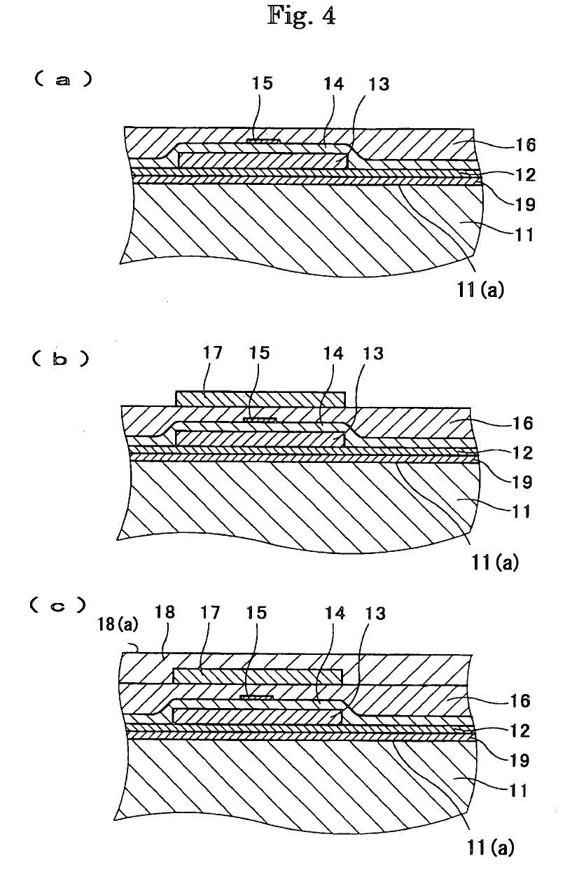

The method of manufacturing the magnetic head of the present invention will be described below with reference to FIGS. 3 and 4 for the example of the MR head shown in FIG. 1. FIGS. 3 and 4 are sectional views descriptive of the method of manufacturing MR head 10.

In the course of manufacturing the MR head of the present invention, at first, a disk-shaped substrate material measuring about four inches, for example, is prepared. The surface of this substrate material is preferably processed by mirror polishing.

Next, as shown in FIG. 3(a), a DLC film 19 is formed on one side surface 11(a) of substrate 11. The DLC film can be formed by sputtering, ion plating method, or the like. The process of forming a DLC film by an ion plating method will be described below.

Benzene gas or some other hydrocarbon gas is introduced into a vacuum chamber to generate hydrocarbon ions or excited radicals in a direct-current arc discharge plasma. Next, hydrocarbon ions are caused to collide by means of energy corresponding to the bias voltage with one side surface 11(a) of substrate 11 that has been biased with a direct-current negative voltage, resulting in solidification. Thus, a DLC film can be formed on substrate 11. The thickness of the DLC thus formed is, as set forth above, preferably equal to or greater than 100 nm, more preferably from 200 to 1,000 nm.

Next, as shown in FIG. 3(b), an insulating layer 12 is formed by sputtering on DLC film 19. Specifically, it is preferable that insulating layer 12 is formed to the thickness of, for example, 15 to 30 μm after the temperature of DLC film 19 decreases and the film becomes stable through passing a prescribed period after the formation of DLC film 19. In the present invention, it is possible to prevent oxygen atoms contained in insulating layer 12 from penetrating into substrate 11 due to impact during the course of the formation of insulating layer 12 since, at this stage, DLC film 19 has already been formed on one side surface 11(a) of substrate 11. Therefore, it is possible to prevent the separation of substrate material particles.

Next, as shown in FIG. 3(c), lower shield layer 13 and lower gap layer 14 are sequentially formed on insulating layer 12. Lower shield layer 13 can be formed by a plating method or by sputtering, for example. In particular, in the present invention, it is preferable to form lower shield layer 13 by a lift-off method described in Japanese Unexamined Patent Publication (KOKAI) No. 2001-101623 since the lower shield layer can be formed with high precision.

When employing sputtering, lower shield layer 13 can be formed as follows. A film comprised of shield layer material (also referred to as “shield material film”, hereinafter) is first formed by sputtering on insulating layer 12. Subsequently, a resist film is formed on the shield material film, photolithographic techniques are used to leave portions of the resist film that are to serve as the magnetic shield, and employing this resist film as a mask, ion etching is used to remove portions of the shield material film that are not covered by resist, thus forming lower shield layer 13. Thereafter, since the surface of the resist film that has been ion-etched has become a carbonized layer, O₂ plasma is employed to remove the carbonized layer portion and a solvent such as acetone is employed to peel off the resist film. However, the sputtering method has problems; for example, the thicker the shield layer becomes, the greater the time that must be spent on ion etching; ion etching may deform the resist film, causing the edge portion of the shield layer to become tapered and making it difficult to control the thickness of the film. Thus, the above-described lift-off method is desirably employed in the present invention.

Next, lower gap layer 14 is formed on lower shield layer 13. Lower gap layer 14 can be formed by sputtering. Thereafter, as shown in FIG. 4(a), magnetoresistive element 15 and upper gap layer 16 are sequentially formed on lower gap layer 14 by sputtering, for example.

As shown in FIG. 4(b), upper shield layer 17 is then formed on upper gap layer 16. Upper shield layer 17 can be formed, in the same manner as when forming the lower shield layer 13 mentioned above, by plating, sputtering, or the lift-off method; among these, the use of the lift-off method is preferred.

Subsequently, as shown in FIG. 4(c), protective layer 18 is formed on upper shield layer 17. Protective layer 18 can be formed by sputtering, vapor deposition, or the like. Next, after protective plate 20 has been bonded to one side surface 18(a) of protective layer 18 with an adhesive such as a resin-based adhesive, end surface 11(b) of substrate 11 and end surface 20(b) of protective plate 20 are polished to form a gently curved sliding surface S of magnetic tape (see FIG. 2). Thus, the MR head can be manufactured.

As described above, since DLC film 19 is provided between substrate 11 and insulating layer 12 in the magnetoresistive head of the present invention, in the course of forming insulating layer 12 as an underlayer on substrate 11 in the process of manufacturing magnetoresistive head 10, the oxygen atoms contained in insulating layer 12 are prevented from penetrating into substrate 11. Accordingly, the bonds between the individual atoms of the material constituting substrate 11 (here, bonds between aluminum, titanium, and carbon) are preserved. Thus, even when pressure is applied to the sliding surface of substrate 11 during reproduction of signals on the magnetic tape, particles of material (here, AlTiC particles) constituting substrate 11 do not separate from the surface of substrate 11. Further, providing a high-strength DLC film on the substrate in the present invention prevents grinding of the substrate edge portion, prevents widening of the groove between the substrate and the insulating layer, and inhibits spacing loss.

The present invention provides a magnetic head with good electromagnetic characteristics in which particles of material constituting the substrate do not separate from the surface of the substrate and the substrate edge portion is not ground even when pressure is applied to the sliding surface of the substrate of the magnetic head during reproduction of signals on a magnetic tape.

The present disclosure relates to the subject matter contained in Japanese Patent Application No. 2003-056646 filed on Mar. 4, 2003, which is expressly incorporated herein by reference in its entirety.

What is claimed is:

1. A magnetic head comprising a film comprised of diamond-like carbon (hereinafter, referred to as “diamond-like carbon film”) between a substrate and an insulating layer.

2. The magnetic head according to claim 1, wherein said film has a Vickers hardness equal to or greater than 2000 kg/mm².

3. The magnetic head according to claim 1, wherein said film has a thickness equal to or greater than 100 nm.

4. The magnetic head according to claim 1, wherein said magnetic head is a magnetoresistive head.

5. The magnetic head according to claim 4, wherein
the diamond-like carbon film, the insulating layer, a lower shield layer, a lower gap layer, a magnetoresistive element, an upper gap layer, an upper shield layer, and a protective layer are provided in this order on one side surface of the substrate.

6. The magnetic head according to claim 5, wherein said substrate is comprised of a nonmagnetic material.

7. The magnetic head according to claim 6, wherein said nonmagnetic material is AlTiC (Al₂O₃·TiC), α-Fe₂O₃ (α-hematite), NiO—TiO₂—MgO, TiO₂—CaO, or NiO—MnO.

8. The magnetic head according to claim 5, wherein said substrate is comprised of a magnetic material.

9. The magnetic head according to claim 8, wherein said magnetic material is Ni—Zn ferrite or Mn—Zn ferrite.

10. The magnetic head according to claim 5, wherein said magnetoresistive element is a magnetoresistive element comprising a lower layer in the form of a tantalum layer, a SAL bias layer in the form of a NiFeNb layer, an intermediate insulating layer in the form of a tantalum layer, a magnetoresistive layer in the form of a NiFe layer, and an upper layer in the form of a tantalum layer in this order.

11. The magnetic head according to claim 5, wherein said substrate has a thickness ranging from 60 to 100 μm.

12. The magnetic head according to claim 5, wherein said insulating layer has a thickness ranging from 15 to 30 μm.

13. The magnetic head according to claim 5, wherein said lower shield layer has a thickness ranging from 2 to 4 μm.

14. The magnetic head according to claim 5, wherein said upper shield layer has a thickness ranging from 2 to 4 μm.

15. The magnetic head according to claim 5, wherein said lower gap layer has a thickness ranging from 60 to 140 nm.

16. The magnetic head according to claim 5, wherein said upper gap layer has a thickness ranging from 80 to 160 nm.

17. The magnetic head according to claim 5, wherein said protective layer has a thickness ranging from 2 to 6 μm.

18. The magnetic head according to claim 4, wherein the substrate is comprised of a nonmagnetic material, and
the diamond-like carbon film, the insulating layer comprised of an insulating material, a lower shield layer comprised of a magnetic material, a lower gap layer comprised of a nonmagnetic material, a magnetoresistive element, an upper gap layer comprised of a nonmagnetic material, an upper shield layer comprised of a magnetic material, and a protective layer comprised of an insulating material are provided in this order on one side surface of the substrate.

19. The magnetic head according to claim 18, wherein said substrate is comprised of AlTiC (Al₂O₃·TiC), α-Fe₂O₃ (α-hematite), NiO—TiO₂—MgO, TiO₂—CaO, or NiO—MnO.

20. The magnetic head according to claim 18, wherein said insulating layer is comprised of alumina (Al₂O₃), silica (SiO₂), AlN, Al—N—X (where X denotes one or more of Si, B, Cr, Ti, Ta and Nb), SiN, SiC, DLC, BN, MgO, SiAlON, AlON, Si₃Na, SiCO, SiON, or SiCON.

21. The magnetic head according to claim 18, wherein said lower shield layer and said upper lower shield layer are respectively comprised of Fe—Si—Al alloy (Sendust), Ni—Fe alloy (Permalloy), or Ni—Zn alloy (hematite).

22. The magnetic head according to claim 18, wherein said lower gap layer and said upper gap layer are respectively comprised of alumina (Al₂O₃) or silica (SiO₂).

23. The magnetic head according to claim 18, wherein said magnetoresistive element is a magnetoresistive element comprising a lower layer in the form of a tantalum layer, a SAL bias layer in the form of a NiFeNb layer, an intermediate insulating layer in the form of a tantalum layer, a magnetoresistive layer in the form of a NiFe layer, and an upper layer in the form of a tantalum layer in this order.

24. The magnetic head according to claim 18, wherein said protective layer is comprised of alumina (Al₂O₃) or silica (SiO₂).

25. The magnetic head according to claim 18, wherein said substrate has a thickness ranging from 60 to 100 μm.

26. The magnetic head according to claim 18, wherein said insulating layer has a thickness ranging from 15 to 30 μm.

27. The magnetic head according to claim 18, wherein said lower shield layer has a thickness ranging from 2 to 4 μm.

28. The magnetic head according to claim 18, wherein said upper shield layer has a thickness ranging from 2 to 4 μm.

29. The magnetic head according to claim 18, wherein said lower gap layer has a thickness ranging from 60 to 140 nm.

30. The magnetic head according to claim 18, wherein said upper gap layer has a thickness ranging from 80 to 160 nm.

31. The magnetic head according to claim 18, wherein said protective layer has a thickness ranging from 2 to 6 μm.
